(19) United States
(12) Patent Application Publication
(10) Pub. No.: US 2002/0050067 A1
(43) Pub. Date: May 2, 2002

(54) Gimbaled lens mount and alignment assembly for a sensitive optical alignment

(76) Inventors: Christopher J. Duska, Lexington, MA (US); Jose Downes, Belmont, MA (US); Masud Azimi, Belmont, MA (US); Kevin McCallion, Boston, MA (US); Parviz Tayebati, Boston, MA (US)

Correspondence Address: Pandiscio & Pandiscio, 470 Totten Pond Road, Waltham, MA, 02451, US

(21) Appl. No.: 09/859,999

(22) Filed: May 17, 2001

Related U.S. Application Data
(60) Provisional application No. 60/204,968, filed on May 17, 2000.

(51) Int. Cl. G01C 15/00

(52) U.S. Cl. 33/286

(57) ABSTRACT

Apparatus is disclosed for aligning optical components. The apparatus comprises a light source providing an emission, an optical element for receiving the emission from the light source, and at least one of the light source and the optical element being mounted to a gimbal mount. Adjustment of the light source and/or the optical element mounted to the gimbal mount adjusts the angle of incidence of the emission from the light source on the optical element. This adjustment in turn aligns the optical components. A method is disclosed for aligning optical components. The method comprises generating an emission from a light source, adjusting a gimbal mount on at least one of the light source and an optical element, wherein the angle of incidence of the emission from the light source is adjusted on the optical element, and fixing in place the position of the gimbal mount on the light source and/or the optical element.

### REFERENCE TO PENDING PRIOR PATENT APPLICATION

This patent application claims benefit of pending prior U.S. Provisional Patent Application Serial No. 60/204,968, filed May 17, 2000 by Chris Duska et al. for GIMBALED LENS MOUNT AND ALIGNMENT ASSEMBLY FOR A SENSITIVE OPTICAL ALIGNMENT (Attorney's Docket No. CORE-65 PROV), which patent application is hereby incorporated herein by reference.

### FIELD OF THE INVENTION

This invention related to optical alignment apparatus and methods in general, and more particularly to apparatus and methods for optical alignment using gimbaled lens mounts.

### BACKGROUND OF THE INVENTION

Sometimes there is a need to precisely align optical components during construction of a system. For example, in the present invention, it is desired to use an etalon to generate an output profile corresponding to the ITU communication grid.

An etalon has a transmission profile characterized by a series of spaced peaks. The angle of incidence of an input beam affects the location of these peaks, the period of these peaks, and the profile of these peaks. Therefore, selection of the proper etalon, and precise alignment of the input beam relative to the etalon, can generate an output profile corresponding to the ITU grid.

A preferred technique for adjusting the output profile of the etalon includes selecting the proper etalon, generating an incident light beam, observing the etalon output, adjusting the angle of incidence until the desired output profile (i.e., the ITU communication grid) is achieved, and then locking the angle of incidence.

### SUMMARY OF THE INVENTION

An object of the invention is to provide an apparatus for aligning optical components.

Another object of the invention is to provide an apparatus for aligning optical components and fixing their position relative to one another.

A further object of the invention is to provide a method for aligning optical components.

With the above and other objects in view, as will hereinafter appear, there is provided an apparatus for aligning optical components, the apparatus comprising: a light source providing an emission; an optical element for receiving the emission from the light source; and at least one of the light source and the optical element being mounted to a gimbal mount, wherein adjustment of the at least one of the light source and the optical element adjusts the angle of incidence of the emission from the light source on the optical element, whereby to align the optical components.

In accordance with a further feature of the invention, there is provided a means for positionally fixing the gimbal mount having an optical component mounted thereto.

In accordance with another feature of the invention, there is provided a method for aligning optical components, the method comprising: generating an emission from a light source; adjusting a gimbal mount on at least one of the light source and an optical element, wherein the angle of incidence of the emission from the light source is adjusted on the optical element; and fixing in place the position of the gimbal mount on the at least one of the light source and the optical element in place.

The above and other features of the invention, including various novel details of construction and combinations of parts and method steps, will now be more particularly described with reference to the accompanying drawings and pointed out in the claims. It will be understood that the particular devices and method steps embodying the invention are shown by way of illustration only and not as limitations of the invention. The principles and features of this invention may be employed in various and numerous embodiments without departing from the scope of the invention.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a perspective view of one form of an apparatus for aligning optical components, illustrative of an embodiment of the invention;

FIG. 2 is a diagrammatic illustration of an apparatus for aligning optical components, showing the socket portion of a horizontal gimbal mount;

FIG. 3 is a diagrammatic illustration of an apparatus for aligning optical components, showing the socket portion of a vertical gimbal mount;

FIG. 4 is a diagrammatic illustration of an apparatus for aligning optical components, showing the counterbore portion of a horizontal gimbal mount;

FIG. 5 is a diagrammatic illustration of an apparatus for aligning optical components, showing the counterbore portion of a vertical gimbal mount;

FIG. 6 is a diagrammatic illustration of an apparatus for aligning optical components, showing the counterbore portion of a vertical gimbal mount; and

FIG. 7 is a diagrammatic illustration of an apparatus for aligning optical components, showing a three-point contact of a gimbal mount.

### DETAILED DESCRIPTION OF THE PREFERRED EMBODIMENTS

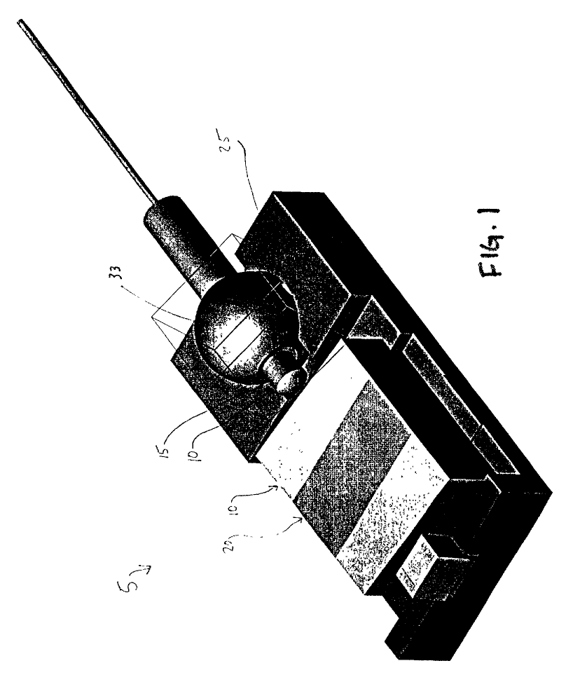

Referring to FIG. 1, apparatus 5 is shown for aligning two optical components 10. In a preferred embodiment of the invention, optical components 10 are generally described herein as a light source 15 and an etalon 20. Apparatus 5 includes light source 15 providing an emission (not shown), etalon 20 receiving the emission from light source 15, and a gimbal mount 25 supporting light source 15. Adjustment of light source 15 supported by gimbal mount 25 changes the angle of incidence of the emission (not shown) on etalon 20 from light source 15. This adjustment in turn aligns optical components 10. In addition, output from etalon 20 may be monitored, i.e., so as to achieve the desired output profile from etalon 20. Gimbal mount 25 is then fixed in position after achieving the desired output profile. This monitoring may include a feedback loop to establish the proper angle of incidence prior to locking gimbal mount 25, or gimbal mounts 25, into position.

In an alternative embodiment (not shown), etalon 20 is mounted to gimbal mount 25. Adjustment of etalon 20 supported by gimbal mount 25 changes the angle of incidence of the emission (not shown) from light source 15 on etalon 20. This adjustment in turn aligns optical components 10. In addition, output from etalon 5 may be monitored, i.e., so as to achieve the desired output profile from etalon 20. Gimbal mount 25 is then fixed in position after achieving the desired output profile from etalon 20. This monitoring may include a feedback loop to establish the proper angle of incidence prior to locking gimbal mount 25, or gimbal mounts 25, into position.

In another alternative embodiment (not shown), both light source 15 and etalon 20 are each mounted on separate gimbal mounts 25. Adjustment of either, or both, light source 15 supported by its own gimbal mount 25 or etalon 20 supported by its own gimbal mount 25 adjusts the angle of incidence of the emission (not shown) from light source 15 on etalon 20. This adjustment in turn aligns the optical components 10. In addition, output from etalon 5 may be monitored, i.e., so as to achieve the desired output profile from etalon 20. The two gimbal mounts 25 are then fixed in position after achieving the desired output profile. This monitoring may include a feedback loop to establish the proper angle of incidence prior to locking gimbal mounts 25 in position.

A method is disclosed for aligning optical components 10. The method comprises generating the emission from light source 15, adjusting light source 15 supported by its own gimbal mount 25 and/or optical element 20 supported by its own gimbal mount 25, wherein the angle of incidence of the emission from light source 15 is adjusted on optical element 20, and fixing in place the position of gimbal mount 25 with light source 15 and/or with optical element 20.

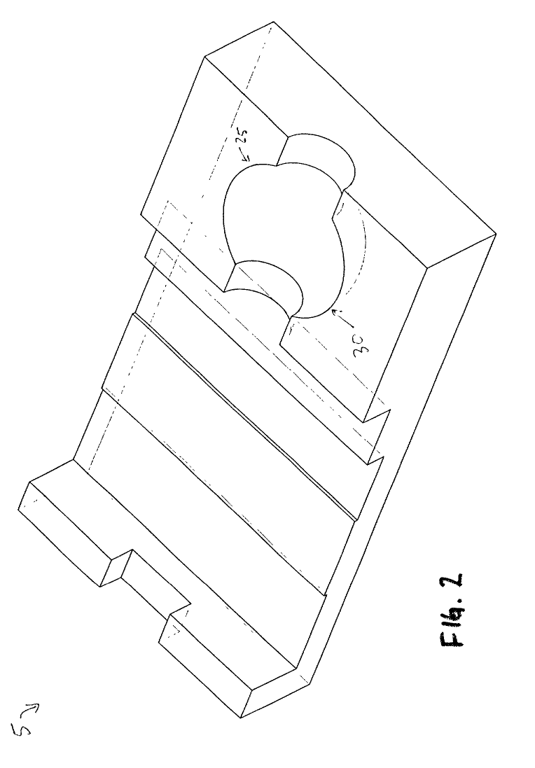

Referring to FIGS. 2-7, there are shown three basic types of gimbal mounts 25.

Looking at FIG. 2, apparatus 5 is shown having a socket 30 formed therein. Socket 30 and the curved element 33 (FIG. 1) together form gimbal mount 25. Socket 30 has a curved surface that corresponds to the outer surface of curved element 33 so as to make surface contact. In this embodiment of the invention, socket 30 is horizontally disposed for horizontal use of apparatus 5.

During use, once the angle of incidence is established, curved element 33 is fixed in position relative to socket 30. This fixation includes, but is not limited to, laser welding, soldering and epoxying curved element 33 at a fixed position relative to socket 30.

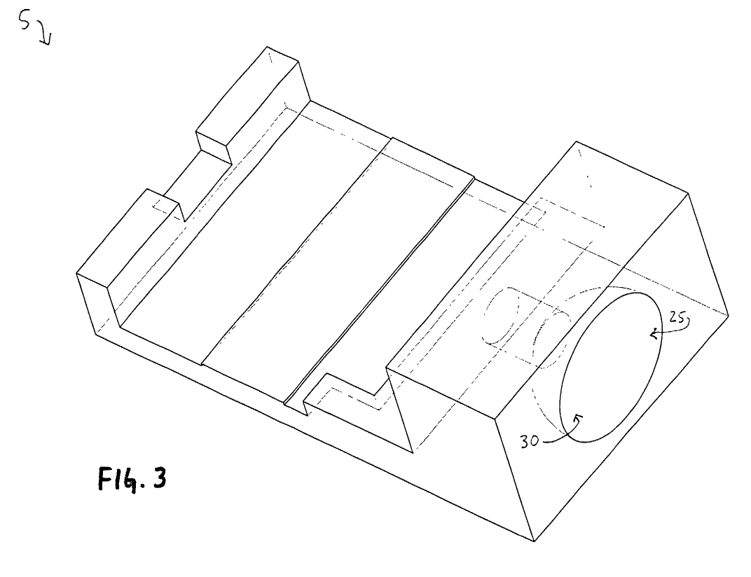

Looking at FIG. 3, apparatus 5 is shown having a socket 30 formed therein. Socket 30 and curved element 33 together form gimbal mount 25. Socket 30 has a curved surface that corresponds to the outer surface of curved element 33 so as to make surface contact. In this embodiment of the invention, socket 30 is vertically disposed for vertical use of apparatus 5.

During use, once the angle of incidence is established, curved element 33 is fixed in position relative to socket 30. This fixation includes, but is not limited to, laser welding, soldering and epoxying curved element 33 at a fixed position relative to socket 30.

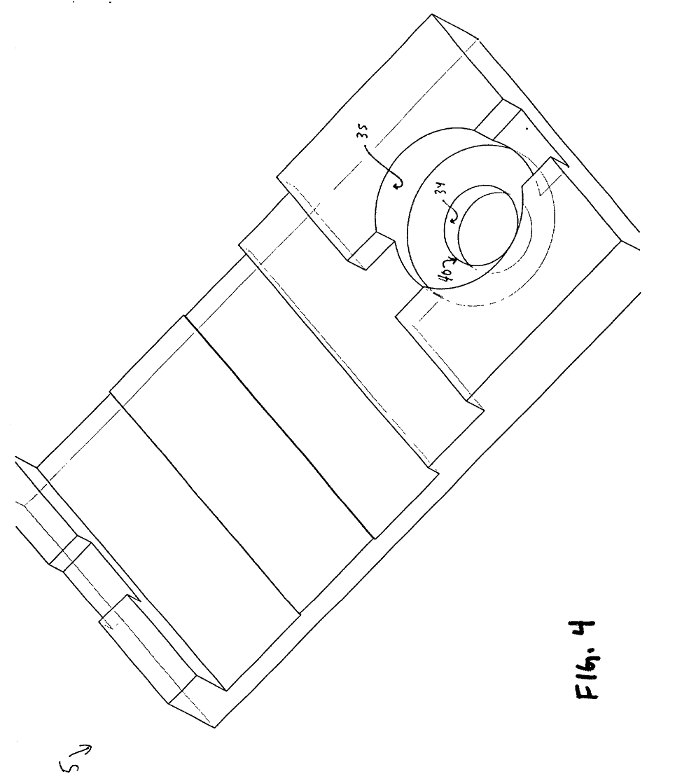

Looking at FIG. 4, apparatus 5 is shown having a bore 34 and counterbore 35 formed therein. Bore 34, counterbore 35 and curved element 33 together form gimbal mount 25. Bore 34 and counterbore 35 form a rim 40 that makes a line contact with curved element 33. In this embodiment of the invention, bore 34 and counterbore 35 are horizontally disposed for horizontal use of apparatus 5.

During use, once the angle of incidence is established, curved element 33 is fixed into position relative to counterbore 35. This fixation includes, but is not limited to, laser welding, soldering and epoxying curved element 33 at a fixed position relative to counterbore 35.

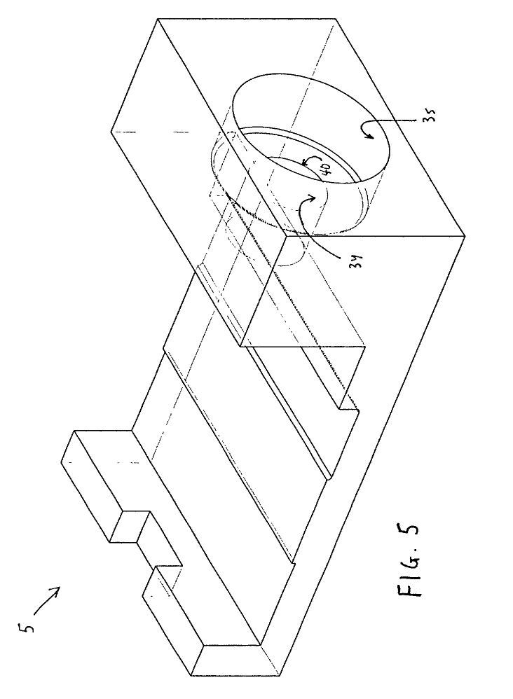

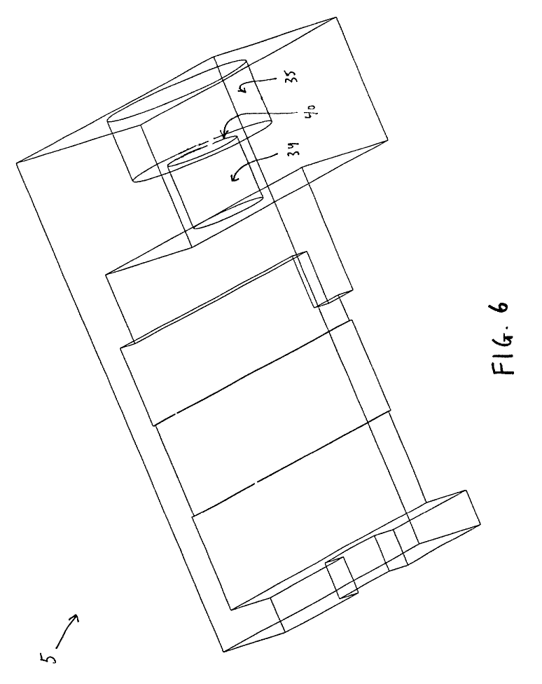

Looking at FIGS. 5 and 6, apparatus 5 is shown having a bore 34 and counterbore 35 formed therein. Bore 34, counterbore 35 and curved element 33 together form gimbal mount 25. Bore 34 and counterbore 35 form rim 40 that makes a line contact with curved element 33. In this embodiment of the invention, bore 34 and counterbore 35 are vertically disposed for vertical use of apparatus 5.

During use, once the angle of incidence is established, curved element 33 is fixed in position relative to counterbore 35. This fixation includes, but is not limited to, laser welding, soldering and epoxying curved element 33 at a fixed position relative to counterbore 35.

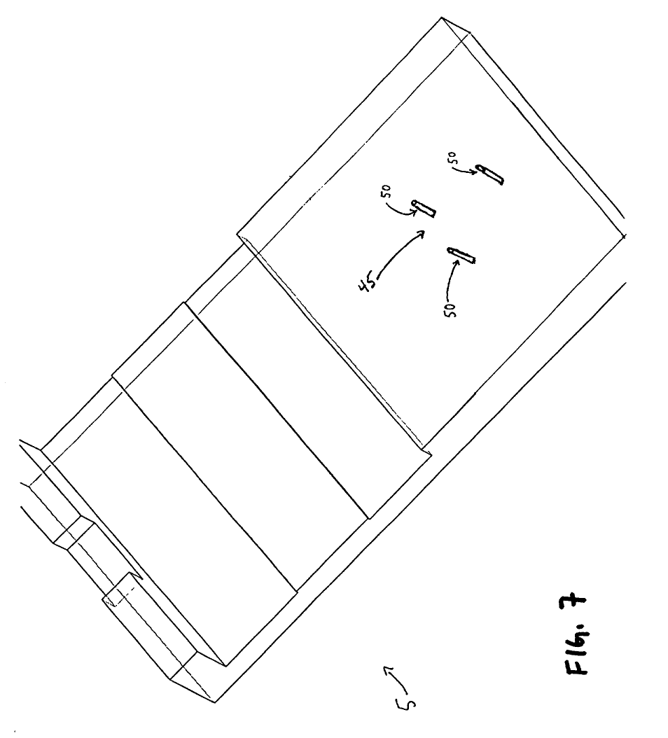

Looking at FIG. 7, apparatus 5 is shown having a multi-point contact 45 formed thereon. Multi-point contact 45 and curved element 33 together form gimbal mount 25. Multi-point contact 45 has three or more posts 50 that make point contact with curved element 33. In this embodiment of the invention, multi-point contact 45 is horizontally disposed for horizontal use of apparatus 5. In another embodiment of the invention (not shown), multi-point contact 45 may be vertically disposed for vertical use of apparatus 5.

In an alternative embodiment (not shown) of the invention, apparatus 5 has a pyramidal opening and a curved element, which together form gimbal mount 25. The pyramidal opening has four sides that make point contact with the curved element.

During use, once the angle of incidence is established, curved element 33 is fixed into position relative to multi-point contact 45. This fixation includes, but is not limited to, laser welding, soldering, epoxying, and resistance welding at the locations where posts 50 contact curved element 33.

In another preferred embodiment (not shown) of the present invention, a single small bore (not shown) with a diameter smaller that the diameter of curved element 33, may be used to seat curved element 33 with a rim contact.

In another preferred embodiment (not shown) of the present invention, a single large bore (not shown), with a diameter effectively the same as curved element 33, may be used to seat curved element 33 with an equatorial contact and a bottom point contact.

What is claimed is:

1. Apparatus for aligning optical components, said apparatus comprising:
a light source providing an emission;
an optical element for receiving said emission from said light source; and
at least one of said light source and said optical element being mounted to a gimbal mount, wherein adjustment of said at least one of said light source and said optical element adjusts the angle of incidence of said emission from said light source on said optical element, whereby to align said optical components.

2. The apparatus of claim 1 wherein said light source is mounted on said gimbal mount.

3. The apparatus of claim 1 wherein said optical element is mounted on said gimbal mount.

4. The apparatus of claim 1 wherein said light source is mounted on said gimbal mount and said optical element is mounted on another gimbal mount.

5. The apparatus of claim 1 wherein said optical element is an etalon.

6. The apparatus of claim 1 wherein said emission is a collimated beam of light.

7. The apparatus of claim 1 wherein said gimbal mount has a socket and a curved surface corresponding to said socket.

8. The apparatus of claim 1 wherein said gimbal mount has a bore and a curved surface corresponding to said bore.

9. The apparatus of claim 8 wherein said bore is smaller than said curved surface, wherein said curved surface is seated on said bore with a line contact.

10. The apparatus of claim 8 wherein said bore has a diameter equal to the diameter of said curved surface, and wherein said curved surface is seated in said bore with an equatorial line contact and a lower point contact.

11. The apparatus of claim 1 wherein said gimbal mount has a bore, a counterbore and a curved surface corresponding to said counterbore.

12. The apparatus of claim 1 wherein said gimbal mount has a support structure and a curved surface corresponding to said support structure so as to form a multi-point contact.

13. The apparatus of claim 1 further comprising means for positionally fixing said gimbal mount, wherein the angle of incidence of said emission of said light source is locked on said optical element.

14. The apparatus of claim 13 wherein said gimbal mount position fixing means is laser welding portions of said gimbal mount together.

15. The apparatus of claim 13 wherein said gimbal mount position fixing means is soldering portions of said gimbal mount together.

16. The apparatus of claim 13 wherein said gimbal mount position fixing means is epoxying portions of said gimbal mount together.

17. The apparatus of claim 13 wherein said gimbal mount position fixing means is resistance welding portions of said gimbal mount together.

18. A method for aligning optical components, said method comprising:
generating an emission from a light source;
adjusting a gimbal mount on at least one of said light source and an optical element, wherein the angle of incidence of said emission from said light source is adjusted on said optical element; and
fixing in place the position of said gimbal mount on said at least one of said light source and said optical element.

19. The method of claim 18 wherein said step of adjusting said gimbal mount is based on a feedback loop.

20. The method of claim 18 wherein said optical element is an etalon.

21. The method of claim 19 further comprising the steps of selecting a proper etalon, observing the output of said selected etalon, adjusting said gimbal mount on said at least one of said light source and said optical element until said output of said selected etalon is a desired ITU grid output, and locking the angle of incidence of said emission of said light source on said selected etalon.

22. The apparatus of claim 12 wherein said support structure comprises at least three posts.

23. The apparatus of claim 12 wherein said support structure has a pyramidal opening to receive said curved surface and form said multi-point contact.
